(19) United States
(12) Patent Application Publication
(10) Pub. No.: US 2006/0138923 A1
(43) Pub. Date: Jun. 29, 2006

(54) PLASMA DISPLAY APPARATUS AND MONO-LAYER OPITICAL FILTER FOR PLASMA DISPLAY APPARATUS AND METHOD OF MANUFACTURING THE SAME

(75) Inventor: Ji Hoon Sohn, Anyang-si (KR)

Correspondence Address: FISH & RICHARDSON P.C., P.O. BOX 1022, MINNEAPOLIS, MN, 55440-1022, US

(73) Assignee: LG Electronics Inc., Yongdungpo-gu (KR)

(21) Appl. No.: 11/275,320

(22) Filed: Dec. 22, 2005

(30) Foreign Application Priority Data
Dec. 29, 2004 (KR) 10-2004-0115788

(51) Int. Cl. H01K 1/30; H01J 17/49

(52) U.S. Cl. 313/110; 313/111; 313/582

(57) ABSTRACT

This document relates to a display apparatus, and more particularly, to a plasma display panel and a mono-layer optical filter for a PDP and manufacturing method thereof. A plasma display apparatus according to an embodiment of the present invention comprises a front panel, an EMI shielding film comprising metal meshes formed in a mesh type, for shielding EMI incident from the front panel, and a medium layer formed around the metal meshes, for shielding NIR, and an AR/hard coating film coated on at least one surface of the EMI shielding film, for shielding the reflection of light incident from the outside. A method of manufacturing a mono-layer optical filter of a PDP according to an embodiment of the present invention comprises the steps of inputting metal meshed in which a conductive material is formed in a mesh type into a molding unit, injecting a mixture in which resin, a NIR absorbing dye and a color compensating dye are mixed into the molding unit, performing a transparency process so that light can pass, erupting the mixture on which the transparency process has been performed in a thin film form, hardening the mixture and then forming an EMI shielding film, and coating an AR/hard coating film for preventing the reflection of light on one surface of the formed EMI shielding film.

### CROSS-REFERENCES TO RELATED APPLICATIONS

This Nonprovisional application claims priority under 35 U.S.C. § 119(a) on Patent Application No. 10-2004-0115788 filed in Korea on Dec. 29, 2004 the entire contents of which are hereby incorporated by reference.

### BACKGROUND OF THE INVENTION

1. Field of The Invention

This document relates to a display apparatus, and more particularly, to a plasma display panel and a mono-layer optical filter for a plasma display panel and manufacturing method thereof.

2. Background of the Related Art

In general, a plasma display apparatus of display apparatuses comprises a plasma display panel and a driver for driving the plasma display panel.

A plasma display panel (hereinafter referred to as “PDP”) implements images by applying a high voltage and a high frequency for a plasma discharge. Therefore, Electromagnetic Interference (hereinafter referred to as “EMI”), which is much stronger than that of the related art display panels, such as a Cathode Ray Tube (CRT) or a Liquid Crystal Display (LCD), is radiated to the front surface of the panel glass.

Furthermore, the PDP radiates Near Infrared Rays (hereinafter referred to as “NIR”) that are induced from an inert gas such as Ne or Xe. The NIR is very similar to the wavelength of the remote controller of home appliances, which may result in malfunction. A problem also arises because a user may feel dazzling from external light. There is also a problem, such as lowered contrast, which is a picture quality characteristic of other display apparatuses. For this reason, a filter for shielding EMI and NIR is generally disposed at the front of the PDP.

The filter generally comprises an EMI shielding film or a NIR shielding film of a film form and the like. The structure of the front filter for the PDP using the same in the related art will be described below depending on the separation type or the integration type.

FIG. 1 is a cross-sectional view illustrating a conductive film type structure of a front filter for a PDP in the related art. FIG. 2 is a cross-sectional view illustrating the structure of an integration type front filter for a PDP in the related art. FIG. 1 shows the separation type front filter comprising a glass substrate and FIG. 2 shows the integration type front filter.

Referring first to FIG. 1, the front filter for the PDP of the conductive film type in the related art comprises a glass substrate 1, a black ceramic layer 2, first, second and third PET films 3, 4 and 5, an Ag/ITO conductive film 6, first, second and third adhesive layers 7a, 7b, 7c (7), first and second Anti-Reflection (AR)/hard coating films 8, 9 and a bus electrode 10. The first PET film 3 in which the first adhesive layer 7a and the first AR/hard coating film 8 are formed on a lower side of the glass substrate 1. The black ceramic layer 2, the second adhesive layer 7b, the second PET film 4, the Ag/ITO conductive film 6, the third adhesive layer 7b, the third PET film 5 and the second AR/hard coating film 9 are sequentially formed on an upper side of the glass substrate 1.

The glass substrate 1 is a substrate made of general tempered glass. The black ceramic layer 2 is a layer for demarcating the boundary of the screen and is formed on a top surface of the glass substrate 1 along the edge.

The Ag/ITO conductive film 6 is a film for shielding EMI and NIR, and is a multi-layered thin film in which an ITO film and an Ag film are alternately deposited. The Ag/ITO conductive film 6 can be generally formed to have five to eleven layers. However, the Ag/ITO conductive film 6 is not limited thereto, but can be varied depending on characteristics of a PDP.

The first and second AR/hard coating films 8,9 are coated on the second and third PET films 4,5 as shown in FIG. 1. The first and second AR/hard coating films 8,9 function to prevent the reflection of light that is incident externally, improve contrast and prevent surface scratch.

The bus electrode 10 is brought in contact with the sides of the Ag/ITO conductive film 6 at the edge of the PDP, and functions to ground the Ag/ITO conductive film 6, thus shielding EMI.

In the front filter for the separation type PDP constructed above in the related art, the Ag/ITO conductive film 6 and the first and second AR/hard coating films 8,9 function to shield EMI and NIR, which are radiated from the front filter, and prevent the reflection of light. However, a contact between the Ag/ITO conductive film 6 and the bus electrode 10 must be perfect in order to shield EMI. This makes the process itself complicate. Problems also arise because an EMI shielding effect is very low upon poor contact and the reappearance and reliability in manufacturing the filter are significantly lowered.

The structure of the front filter of the integration type PDP in the related art will be then described below with reference to FIG. 2. As shown in FIG. 2, the front filter comprises an ultraviolet shielding film 21, as a glass substrate, which is located on an upper plate of a PDP, a black ceramic layer 22 formed at the circumference of the ultraviolet shielding film 21, for clearly dividing the boundary of the screen, a NIR shielding film 23 over the black ceramic layer 22 with a first adhesive layer 26a intervened therebetween, an EMI shielding electrode 24 formed on the NIR shielding film 23, a PET film 25 formed over the EMI shielding electrode 24 with a second adhesive layer 26b intervened therebetween, a second adhesive layer 26c attached to the PET film 25, and a bus electrode 27.

The EMI shielding electrode 24 is formed of the conductive film used in the front filter for the aforementioned separation type PDP.

As described above, the front filter for the PDP in the related art are disadvantageous in that the process itself is complicated, a unit price is high because the number of process is many, and management of alien substance is difficult because the interface is a lot in process.

### SUMMARY OF THE INVENTION

Accordingly, an object of an embodiment of the present invention is to solve at least the problems and disadvantages of the background art.

It is an object of an embodiment of the present invention to shield EMI and NIR incident from a PDP.

It is another object of an embodiment of the present invention to make thin a thickness of a plasma display apparatus.

It is still another object of an embodiment of the present invention to maximize production efficiency by simplifying the manufacturing process into an in-line process.

To accomplish the above objects, a display apparatus according to an embodiment of the present invention comprises a front panel, an EMI shielding film comprising metal meshes formed in a mesh type, for shielding EMI incident from the front panel, and a medium layer formed around the metal meshes, for shielding NIR, and an AR/hard coating film coated on at least one surface of the EMI shielding film, for shielding the reflection of light incident from the outside.

A mono-layer optical filter for a PDP according to another embodiment of the present invention comprises an EMI shielding film comprising metal meshes formed in a mesh type, for shielding EMI incident from a front panel, and a medium layer formed around the metal meshes, for shielding NIR, and an AR/hard coating film coated on at least one surface of the EMI shielding film, for shielding the reflection of light incident from the outside.

A method of manufacturing a mono-layer optical filter of a PDP according to still another embodiment of the present invention comprises the steps of: inputting metal meshes in which a conductive material is formed in a mesh type into a molding unit; injecting a mixture in which resin, a NIR absorbing dye and a color compensating dye are mixed into the molding unit to form a resultant mixture; performing a transparency process on the resultant mixture so that light can pass through the resultant mixture; erupting the mixture on which the transparency process has been performed in a thin film form, hardening the mixture and then forming an EMI shielding film; and coating an AR/hard coating film for preventing the reflection of light on one surface of the formed EMI shielding film.

In accordance with an embodiment of the present invention, a single layer can be formed through simplification of the existing front filter structure for a PDP. Therefore, a single filter can not only shield EMI and NIR incident from the PDP, but also can provide a color compensating function. There is also an advantage in that a plasma display apparatus can be made thin.

In accordance with an embodiment of the present invention, the manufacturing process can be performed as an in-line process. Therefore, there are advantages in that production efficiency can be increased and the low price of manufactured products can be realized.

### BRIEF DESCRIPTION OF THE DRAWINGS

The embodiment of the invention will be described in detail with reference to the following drawings in which like numerals refer to like elements.

FIG. 1 is a cross-sectional view illustrating a conductive film type structure of a front filter for a PDP in the related art;

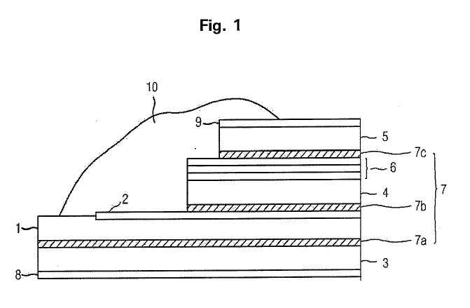

FIG. 2 is a cross-sectional view illustrating the structure of an integration type front filter for a PDP in the related art;

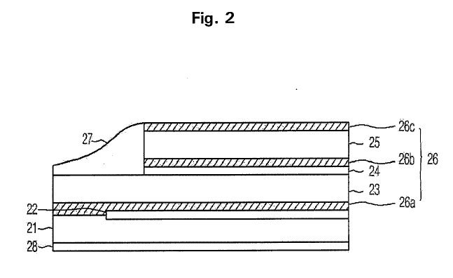

FIG. 3 is a cross-sectional view illustrating the structure of a plasma display apparatus according to an embodiment of the present invention;

FIG. 4 is a view illustrating a method of manufacturing a mono-layer optical filter for a PDP according to an embodiment of the present invention; and

FIG. 5 shows an embodiment of a manufacturing process according to the procedure shown in FIG. 4.

### DETAILED DESCRIPTION OF THE PREFERRED EMBODIMENT

Embodiments of the present invention will be described in a more detailed manner with reference to the drawings.

A display apparatus according to an embodiment of the present invention comprises

a front panel, an EMI shielding film comprising metal meshes formed in a mesh type, for shielding EMI incident from the front panel, and a medium layer formed around the metal meshes, for shielding NIR, and an AR/hard coating film coated on at least one surface of the EMI shielding film, for shielding the reflection of light incident from the outside.

The plasma display apparatus further comprises an adhesive layer formed on the other surface of the EMI shielding film, for facilitating adhesion with the front panel.

A conductive material of the metal meshes comprising at least one of copper (Cu), nickel (Ni), cobalt (Co), zinc (Zn), chrome (Cr) and transition metal oxides are selected and then mixed.

A medium layer of the EMI shielding film comprising at least one of a resin, a NIR absorbing dye for absorbing and shielding the NIR, and a color compensating dye for color compensation are mixed.

The resin comprising at least one of an acrylate-based, ehtacrylate-based, vinyl-based, methacryl-based, an alkyl group, an unsaturated higher fatty acid group, a tetrahydrofurfulyl group and a benzyl ether group.

The NIR absorbing dye comprising at least one of di-immonium-based, metal complex-based and phyahlocyanine-based dyes.

The color compensating dye comprising at least one of a cyanine-based dye and a phorpyrin-based dye.

The filter has a thickness of 20 μm to 5 mm.

A mono-layer optical filter for a PDP according to another embodiment of the present invention comprises an EMI shielding film comprising metal meshes formed in a mesh type, for shielding EMI incident from a front panel, and a medium layer formed around the metal meshes, for shielding NIR, and an AR/hard coating film coated on at least one surface of the EMI shielding film, for shielding the reflection of light incident from the outside.

The mono-layer optical filter further comprises an adhesive layer formed on the other surface of the EMI shielding film, for facilitating adhesion with the front panel.

A conductive material of the metal meshes comprising at least one of copper (Cu), nickel (Ni), cobalt (Co), zinc (Zn), chrome (Cr) and transition metal oxides are selected and then mixed.

A medium layer of the EMI shielding comprising at least one of a resin, a NIR absorbing dye for absorbing and shielding the NIR, and a color compensating dye for color compensation are mixed.

The resin comprising at least one of an acrylate-based, ehtacrylate-based, vinyl-based, methacryl-based, an alkyl group, an unsaturated higher fatty acid group, a tetrahydrofurfulyl group and a benzyl ether group.

The NIR absorbing dye comprising at least one of di-immonium-based, metal complex-based and phyahlocyanine-based dyes.

The color compensating dye comprising at least one of a cyanine-based dye and a phorpyrin-based dye.

The filter has a thickness of 20 μm to 5 mm.

A method of manufacturing a mono-layer optical filter of a PDP according to still another embodiment of the present invention comprises the steps of inputting metal meshes in which a conductive material is formed in a mesh type into a molding unit, injecting a mixture in which resin, a NIR absorbing dye and a color compensating dye are mixed into the molding unit, performing a transparency process so that light can pass, erupting the mixture on which the transparency process has been performed in a thin film form, hardening the mixture and then forming an EMI shielding film, and coating an AR/hard coating film for preventing the reflection of light on one surface of the formed EMI shielding film.

An embodiment of the present invention will be described below with reference to the accompanying drawings.

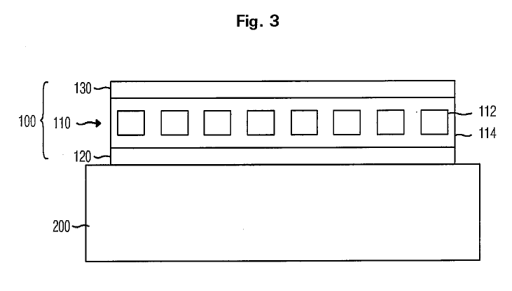

FIG. 3 is a cross-sectional view illustrating the structure of a plasma display apparatus according to an embodiment of the present invention.

As shown in FIG. 3, the plasma display apparatus according to an embodiment of the present invention comprises a front panel 200, and a mono-layer optical filter 100 comprising of a number of layers 110, 120 and 130 attached to the entire surface of the front panel 200.

The mono-layer optical filter 100 comprising of a number of the layers 110, 120 and 130 for improving an overall performance of the plasma display apparatus is formed on the entire surface of the front panel 200.

As shown in FIG. 3, the mono-layer optical filter 100 for a PDP according to an embodiment of the present invention comprises an EMI shielding film 110 comprising a NIR absorbing dye and a color compensating dye, and an AR/hard coating layer 130 formed on the front surface of the EMI shielding film 110. Furthermore, an adhesive layer 120 for attaching the front panel 200 for a PDP can be further formed on the rear surface of the EMI shielding film 110.

The EMI shielding film 110 has a structure in which a conductive material, such as copper (Cu), is formed as a network within a valid surface. The EMI shielding film 110 comprises metal meshes 112 having a sheet form for the purpose of ground at the invalid surface portions, and a medium layer 114, which has at least one of an NIR absorbing dye, a color compensating dye and resin mixed therein and is formed to surround betweens-the-metal meshes 112 and the top and bottom surfaces, of the metal meshes 112. The medium layer 114 is not formed at a portion where a metal sheet will be grounded.

Therefore, in the structure constructed above, an electric field applied to the metal meshes 112 can shield EMI. Furthermore, the NIR absorbing dye and the color compensating dye of the medium layer 114 can shield NIR incident from the front panel 200 for a PDP and can also align transmittance balance of red (R), green (G) and blue (B) of light incident from the front panel 200 for a PDP, increasing optical efficiency.

A conductive material of the metal meshes 112 comprising at least one of copper (Cu), nickel (Ni), cobalt (Co), zinc (Zn), chrome (Cr) and transition metal oxides are selected and then mixed. Resin constituting the medium layer 114 is resin having a reactor such as acrylate-based, ehtacrylate-based, vinyl-based, methacryl-based, an alkyl group, an unsaturated higher fatty acid group, a tetrahydrofurfulyl group or a benzyl ether group. The NIR absorbing dye comprising at least one of a di-immonium-based, metal complex-based and phyahlocyanine-based dye. Furthermore, the color compensating dye of the medium layer 114 may use at least one of cyanine-based and phorpyrin-based dye.

Furthermore, the AR/hard coating film 130 functions to prevent the reflection of light incident from the outside, improving contrast and thus alleviating fatigue of the eyes, and also prevent surface scratch. The AR/hard coating film 130 can be attached on the EMI shielding film 110 by a laminating process even without using an additional adhesive, by way of the adhesive property of resin mixed in the medium layer 114 of the EMI shielding film 110.

Therefore, in the mono-layer optical filter 100 for a PDP constructed above according to an embodiment of the present invention, the EMI shielding film 110 (i.e., a single layer) can shield EMI and NIR, which are incident from the front panel 200 for a PDP, at the same time. Furthermore, the AR/hard coating film 130 attached to the EMI shielding film 110 can prevent the reflection of light. It is thus possible to improve contrast without lowering a brightness of a PDP. The filter 100 can be made thin 20 μm to 5 mm in total thickness, preferably 100 μm to 300 μm.

The mono-layer optical filter 100 for a PDP according to an embodiment of the preset invention can be manufactured according to the following process.

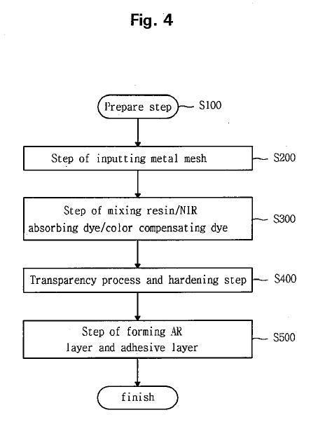

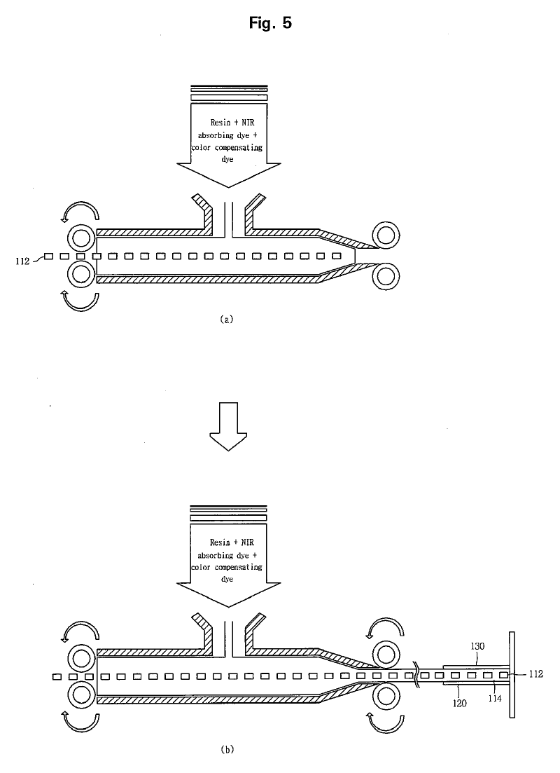

FIG. 4 is a view illustrating a method of manufacturing the mono-layer optical filter for a PDP according to an embodiment of the present invention. FIG. 5 shows an embodiment of a manufacturing process according to the procedure shown in FIG. 4.

Referring to FIGS. 4 and 5, as a preparation step, the metal meshes 112 of a predetermined size, in which a conductive material is formed to have a mesh type are prepared. Dye and resin materials for NIR and color compensation are prepared. Molding units, each having an inlet and an exhaust nozzle, for molding the metal meshes 112 and the dye and resin materials, respectively, are prepared at step S100.

As shown in FIG. 5(a), the metal meshes 112 of a predetermined size, in which an EMI shielding layer will be formed, are inputted into the molding unit. The resin, the NIR absorbing dye and the color compensating dye, which have been prepared in the preparation step, are mixed to form a resultant mixture. The resultant mixture is injected through the inlet of the molding unit at steps S200, S300.

In this case, where the dyes are formed to have a powder form, they can be modified into a gel form of a liquid phase as being directly heated within the molding unit, or can be modified into a get form of a liquid phase before injection. In the case where the dyes are prepared to have a get form of a liquid phase, they can be directly injected through the inlet of the molding unit. This technology has already been known in the art to the extent that those skilled in the art can easily modify it. Therefore, detailed description thereof will be omitted.

After a transparency process is performed, the dyes are erupted through the exhaust nozzle at step S400.

Upon eruption, a mixture formed around the metal meshes 112 is erupted toward the outside, while forming a predetermined thin film through a roller, which is disposed in the exhaust nozzle of the molding unit and moves up and down in cooperation with the exhaust nozzle of the molding unit, as shown in FIG. 5(b). The erupted mixture is hardened to form a hard EMI shielding film 110, which comprises of the metal meshes 112 at valid surface portions and a metal ground layer at invalid surface portions.

Thereafter, the AR/hard coating film 130, for preventing the reflection of light to reduce the fatigue of the eyes and preventing surface scratch, is coated on the front surface of the formed EMI shielding film 110 by the lamination process at step S500.

The adhesive layer 120 for facilitating the attachment of the front panel 200 for a PDP can be further formed on the rear surface of the EMI shielding film 110, if appropriate, at step S500. The fabrication of the mono-layer optical filter according to an embodiment of the present invention is thereby completed.

The manufacturing process as described above according to an embodiment of the present invention can be carried out as an in-line process. It is thus possible to simplify the manufacturing process and also to maximize production efficiency. Furthermore, EMI and NIR shielding and color compensation can be provided at the same time through the EMI shielding film 110 of a single layer.

As described above, since a single layer is formed by simplifying the structure of the front filter for a PDP, not only EMI and NIR incident from the panel of the PDP can be shielded, but also a color compensating function can be provided using one filter. There is also an advantage in that a plasma display apparatus can be made thin.

Furthermore, there are advantages in that production efficiency can be increased and the low price of manufactured products can be realized because the manufacturing process can be performed as an in-line process.

The invention being thus described, it will be obvious that the same may be varied in many ways. Such variations are not to be regarded as a departure from the spirit and scope of the invention and all such modifications as would be obvious to one skilled in the art are intended to be included within the scope of the following claims.

What is claimed is:

1. A plasma display apparatus comprising:
a front panel;
an EMI shielding film comprising metal meshes formed in a mesh type, for shielding EMI incident from the front panel, and a medium layer formed around the metal meshes, for shielding NIR; and
an AR/hard coating film coated on at least one surface of the EMI shielding film, for shielding the reflection of light incident from the outside.

2. The plasma display apparatus as claimed in claim 1, further comprising an adhesive layer formed on the other surface of the EMI shielding film, for facilitating adhesion with the front panel.

3. The plasma display apparatus as claimed in claim 2, wherein a conductive material of the metal meshes comprising at least one of copper (Cu), nickel (Ni), cobalt (Co), zinc (Zn), chrome (Cr) and transition metal oxides.

4. The plasma display apparatus as claimed in claim 3, wherein a medium layer of the EMI shielding film comprising at least one of a resin, a NIR absorbing dye for absorbing and shielding the NIR, and a color compensating dye for color compensation.

5. The plasma display apparatus as claimed in claim 4, wherein the resin comprising at least one of an acrylate-based, ehtacrylate-based, vinyl-based, methacryl-based, an alkyl group, an unsaturated higher fatty acid group, a tetrahydrofurfulyl group and a benzyl ether group.

6. The plasma display apparatus as claimed in claim 4, wherein the NIR absorbing dye comprising at least one of di-immonium-based, metal complex-based and phyahlocyanine-based dyes.

7. The plasma display apparatus as claimed in claim 4, wherein the color compensating dye comprising at least one of a cyanine-based dye and a phorpyrin-based dye.

8. The plasma display apparatus as claimed in claim 1, wherein the filter has a thickness of 20 μm to 5 mm.

9. A mono-layer optical filter for a PDP, comprising:
an EMI shielding film comprising metal meshes formed in a mesh type, for shielding EMI incident from a front panel, and a medium layer formed around the metal meshes, for shielding NIR; and
an AR/hard coating film coated on at least one surface of the EMI shielding film, for shielding the reflection of light incident from the outside.

10. The mono-layer optical filter as claimed in claim 9, further comprising an adhesive layer formed on the other surface of the EMI shielding film, for facilitating adhesion with the front panel.

11. The mono-layer optical filter as claimed in claim 10, wherein a conductive material of the metal meshes comprising at least one of copper (Cu), nickel (Ni), cobalt (Co), zinc (Zn), chrome (Cr) and transition metal oxides.

12. The mono-layer optical filter as claimed in claim 11, wherein a medium layer of the EMI shielding film comprising at least one of a resin, a NIR absorbing dye for absorbing and shielding the NIR, and a color compensating dye for color compensation.

13. The mono-layer optical filter as claimed in claim 12, wherein the resin comprising at least one of an acrylate-based, ehtacrylate-based, vinyl-based, methacryl-based, an alkyl group, an unsaturated higher fatty acid group, a tetrahydrofurfulyl group and a benzyl ether group.

14. The mono-layer optical filter as claimed in claim 12, wherein the NIR absorbing dye comprising at least one of di-immonium-based, metal complex-based and phyahlocyanine-based dyes.

15. The mono-layer optical filter as claimed in claim 12, wherein the color compensating dye comprising at least one of a cyanine-based dye and a phorpyrin-based dye.

16. The mono-layer optical filter as claimed in claim 9, wherein the filter has a thickness of 20 μm to 5 mm.

17. A method of manufacturing a mono-layer optical filter of a PDP, the method comprising the steps of:
inputting metal meshes in which a conductive material is formed in a mesh type into a molding unit;
injecting a mixture in which resin, a NIR absorbing dye and a color compensating dye are mixed into the molding unit to form a resultant mixture;
performing a transparency process on the resultant mixture so that light can pass through the resultant mixture;
erupting the mixture on which the transparency process has been performed in a thin film form, hardening the mixture and then forming an EMI shielding film; and
coating an AR/hard coating film for preventing the reflection of light on one surface of the formed EMI shielding film.
